(19) United States
(12) Patent Application Publication
(10) Pub. No.: US 2019/0275776 A1
(43) Pub. Date: Sep. 12, 2019

(54) OPTICAL FILM, PRODUCTION METHOD AND MULTILAYER FILM

(71) Applicant: ZEON CORPORATION, Chiyoda-ku, Tokyo (JP)

(72) Inventor: Sogo KOMOTO, Tokyo (JP)

(73) Assignee: ZEON CORPORATION, Chiyoda-ku, Tokyo (JP)

(21) Appl. No.: 16/343,054

(22) PCT Filed: Oct. 25, 2017
(86) PCT No.: PCT/JP2017/038580

§ 371 Date: Apr. 18, 2019

(30) Foreign Application Priority Data
Oct. 31, 2016 (JP) 2016-213109

(51) Int. Cl. B32B 27/40; B32B 27/36; B32B 7/12

(52) U.S. Cl. CPC B32B 27/40; B32B 27/365; C08G 18/44; B32B 2457/202; B32B 7/12

(57) ABSTRACT

An optical film, etc., including a first layer, and an easy-adhesion layer disposed on at least one surface of the first layer, wherein the first layer is a layer of a crystallized resin including an alicyclic structure-containing polymer, and the easy-adhesion layer is a layer of a urethane resin; and a method for producing the optical film including a step (1) of molding a crystallizable resin including an alicyclic structure-containing polymer to obtain a crystallizable resin film having a crystallization degree of less than 3%; a step (2) of forming an easy-adhesion layer on the surface of the crystallizable resin film to obtain a multilayer product including the crystallizable resin film and the easy-adhesion layer; and a step (4) of crystallizing the crystallizable resin film in the multilayer product.

### FIELD

The present invention relates to an optical film, a production method thereof, and a multilayer film including the optical film.

### BACKGROUND

An optical film made of a resin is commonly provided in display devices such as a liquid crystal display device and an organic electroluminescent display device. For example, it is known that, in the display device having a function of detecting an operation of a user, such as a touch panel, a flexible optical film made of a resin is disposed on the surface of the display device to constitute a touch sensor.

Such an optical film is required to have properties such as heat resistance and flexibility. It has been proposed to use a crystallized resin that includes an alicyclic structure-containing polymer as the optical film having such properties (for example, Patent Literatures 1 and 2).

### CITATION LIST

### Patent Literature

Patent Literature 1: Japanese Patent Application Laid-Open No. 2014-105291 A

Patent Literature 2: Japanese Patent Application Laid-Open No. 2016-008283 A

### SUMMARY

### Technical Problem

In addition to the properties described above, the optical film to be integrated into the display device is required to have an adhesive property, that is, a capability for readily achieving adhesion with other constituent elements of the device. For example, the optical film constituting the touch sensor is required to be capable of adhering to other elements constituting the touch sensor with high peel strength in order to ensure high durability of the device itself. However, it is difficult to ensure such a high adhesive property of the crystallized resin including the alicyclic structure-containing polymer.

Thus, an object of the present invention is to provide an optical film having a high adhesive property in addition to properties such as high heat resistance and high flexibility, and a production method capable of easily producing such an optical film.

Another object of the present invention is to provide a multilayer film having properties such as high heat resistance and high flexibility, having a low tendency to cause peeling between layers, and having high durability.

### Solution to Problem

As a result of studies for solving the aforementioned problems, the present inventor has found that the problem of ensuring the adhesive property can be solved by combining a crystallized resin including an alicyclic structure-containing polymer and a layer of a specific material. The present invention has been completed on the basis of such finding.

According to the present invention, the following is provided.

<1> An optical film comprising a first layer, and an easy-adhesion layer disposed on at least one surface of the first layer, wherein

the first layer is a layer of a crystallized resin including an alicyclic structure-containing polymer, and

the easy-adhesion layer is a layer of a urethane resin.

<2> The optical film according to <1>, wherein a haze of the first layer is 3.0% or less.

<3> The optical film according to <1> or <2>, wherein the urethane resin contains a polycarbonate-based polyurethane containing a carbonate structure in a skeleton thereof.

<4> A method for producing the optical film according to any one of <1> to <3>, comprising:

a step (1) of molding a crystallizable resin including an alicyclic structure-containing polymer to obtain a crystallizable resin film having a crystallization degree of less than 3%;

a step (2) of forming an easy-adhesion layer on the surface of the crystallizable resin film to obtain a multilayer product including the crystallizable resin film and the easy-adhesion layer; and

a step (4) of crystallizing the crystallizable resin film in the multilayer product.

<5> The method for producing the optical film according to <4>, further comprising a step (3) of stretching the crystallizable resin film prior to the step (4).

<6> A multilayer film comprising:

the optical film according to any one of <1> to <3>;

an adhesive layer disposed on a surface of the optical film on the easy-adhesion layer side; and

a second layer disposed on the adhesive layer.

### Advantageous Effects of Invention

The optical film of the present invention has a high adhesive property in addition to properties such as high heat resistance and high flexibility. According to the method for producing an optical film of the present invention, such an optical film can be easily produced. The multilayer film of the present invention has properties such as high heat resistance and high flexibility, has a low tendency to cause peeling between layers, and has high durability.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a “long-length” film refers to a film with the length that is 5 times or more the width, and preferably a film with the length that is 10 times or more the width, and specifically refers to a film having a length that allows a film to be wound up into a rolled shape for storage or transportation. The upper limit of the ratio of the length to the width of the film is not particularly limited, and is, for example, 100,000 times or less.

In the following description, directions of elements being “parallel”, “perpendicular”, and “orthogonal” may allow an error within the range of not impairing the advantageous effects of the present invention, for example, within a range of ±5°, unless otherwise specified.

[1. Outline of Optical Film]

The optical film of the present invention includes a first layer, and an easy-adhesion layer which is disposed on at least one surface of the first layer.

[2. First Layer]

The first layer is a layer of a crystallized resin including an alicyclic structure-containing polymer.

The crystallized resin is a resin having a predetermined crystallization degree. The crystallization degree of the crystallized resin is 30% or more, preferably 50% or more, and more preferably 60% or more. The upper limit of the crystallization degree is ideally 100%, although it may usually be 90% or less or 80% or less.

The crystallization degree is an index that indicates a ratio of the crystallized alicyclic structure-containing polymers among the alicyclic structure-containing polymers having crystallizability included in the first layer. The crystallization degree of the alicyclic structure-containing polymers included in the first layer may be measured by an X-ray diffraction method. Specifically, an X-ray diffraction intensity from a crystallized area is obtained using a wide-angle X-ray diffractometer (for example, RINT 2000 manufactured by Rigaku Corp.) in accordance with JIS K 0131, and the crystallization degree may be determined from a ratio of the X-ray diffraction intensity from the crystallized area with respect to the total X-ray diffraction intensity by the following formula (I).

Xc=K·Ic/It (I)

In the above formula (I), Xc represents the crystallization degree of the test sample, Ic represents the X-ray diffraction intensity from the crystallized area, It represents the overall X-ray diffraction intensity, and K represents a correction factor.

The crystallized resin may be formed by crystallizing the crystallizable resin including the alicyclic structure-containing polymer.

In the present application, the alicyclic structure-containing polymer included in the crystallizable resin refers to a polymer that has an alicyclic structure in the molecule and is obtainable by a polymerization reaction using a cyclic olefin as a monomer, or a hydrogenated product thereof. As the alicyclic structure-containing polymer, one type thereof may be solely used, and two or more types thereof may also be used in combination at any ratio.

Examples of the alicyclic structure contained in the alicyclic structure-containing polymer may include a cycloalkane structure, and a cycloalkene structure. Among these, a cycloalkane structure is preferable from the viewpoint of easily obtaining a first layer excellent in properties such as thermal stability. The number of carbon atoms contained per alicyclic structure is preferably 4 or more, and more preferably 5 or more, and is preferably 30 or less, more preferably 20 or less, and particularly preferably 15 or less. When the number of carbon atoms contained in one alicyclic structure falls within the aforementioned range, mechanical strength, heat resistance, and moldability are highly balanced.

In the alicyclic structure-containing polymer, the ratio of the structural unit having an alicyclic structure relative to all structural units is preferably 30% by weight or more, more preferably 50% by weight or more, and particularly preferably 70% by weight or more. When the ratio of the structural unit having an alicyclic structure in the alicyclic structure-containing polymer is at such a high level as described above, the advantageous effects of the present invention such as high flexibility can be enhanced.

The rest of the alicyclic structure-containing polymer other than the structural unit having an alicyclic structure is not particularly limited, and may be appropriately selected depending on the purposes of use.

The alicyclic structure-containing polymer contained in the crystallizable resin has crystallizability. The “alicyclic structure-containing polymer having crystallizability” herein refers to an alicyclic structure-containing polymer having a melting point Tm (that is, a melting point thereof can be observed by a differential scanning calorimeter (DSC)). The melting point Tm of the alicyclic structure-containing polymer is preferably 200° C. or higher, and more preferably 230° C. or higher, and is preferably 290° C. or lower. By using the alicyclic structure-containing polymer having such a melting point Tm, a desired crystallization degree in the present invention can be easily achieved.

The weight-average molecular weight (Mw) of the alicyclic structure-containing polymer is preferably 1,000 or more, and more preferably 2,000 or more, and is preferably 1,000,000 or less, and more preferably 500,000 or less. The alicyclic structure-containing polymer having such a weight-average molecular weight has excellent balance of molding processability and flexibility.

The molecular weight distribution (Mw/Mn) of the alicyclic structure-containing polymer is preferably 1.0 or more, and more preferably 1.5 or more, and is preferably 4.0 or less, and more preferably 3.5 or less. Herein, Mn represents a number-average molecular weight. The alicyclic structure-containing polymer having such a molecular weight distribution has excellent molding processability.

The weight-average molecular weight (Mw) and the molecular weight distribution (Mw/Mn) of the alicyclic structure-containing polymer may be measured as a polystyrene-equivalent value by gel permeation chromatography (GPC) using tetrahydrofuran as a developing solvent.

The glass transition temperature Tg of the alicyclic structure-containing polymer is not particularly limited, but is usually 85° C. or higher and is usually 170° C. or lower.

Examples of the alicyclic structure-containing polymer may include the following polymer (α) to polymer (δ). Among these, the polymer (β) is preferable as the alicyclic structure-containing polymer having crystallizability because the first layer having excellent flexibility can be easily obtained therewith.

Polymer (α): a ring-opening polymer of a cyclic olefin monomer having crystallizability

Polymer (β): a hydrogenated product of the polymer (α) having crystallizability

Polymer (γ): an addition polymer of a cyclic olefin monomer having crystallizability

Polymer (δ): a hydrogenated product and the like of the polymer (γ) having crystallizability

Specifically, the alicyclic structure-containing polymer is more preferably a ring-opening polymer of dicyclopentadiene having crystallizability or a hydrogenated product of the ring-opening polymer of dicyclopentadiene having crystallizability. The alicyclic structure-containing polymer is particularly preferably a hydrogenated product of the ring-opening polymer of dicyclopentadiene having crystallizability. Herein, the ring-opening polymer of dicyclopentadiene refers to a polymer in which the ratio of a structural unit derived from dicyclopentadiene relative to all structural units is usually 50% by weight or more, preferably 70% by weight or more, more preferably 90% by weight or more, and further preferably 100% by weight.

Hereinafter, methods for producing the polymer (α) and the polymer (β) will be described.

The cyclic olefin monomer available for producing the polymer (α) and the polymer (β) is a compound which has a ring structure formed of carbon atoms and includes a carbon-carbon double bond in the ring. Examples of the cyclic olefin monomer may include a norbornene-based monomer. When the polymer (α) is a copolymer, a monocyclic olefin may be used as the cyclic olefin monomer.

The norbornene-based monomer is a monomer containing a norbornene ring. Examples of the norbornene-based monomer may include a bicyclic monomer such as bicyclo[2.2.1]hept-2-ene (common name: norbornene) and 5-ethylidene-bicyclo[2.2.1]hept-2-ene (common name: ethylidene norbornene) and derivatives thereof (for example, those with a substituent on the ring); a tricyclic monomer such as tricyclo[4.3.0.1^{2,5}]deca-3,7-diene (common name: dicyclopentadiene) and derivatives thereof; and a tetracyclic monomer such as 7,8-benzotricyclo[4.3.0.1^{2,5}]dec-3-ene (common name: methanotetrahydrofluorene: also referred to as 1,4-methano-1,4,4a, 9a-tetrahydrofluorene) and derivatives thereof, tetracyclo[4.4.0.1^{2,5}.1^{7,10}]dodec-3-ene (common name: tetracyclododecene), and 8-ethylidenetetracyclo[4.4.0.1^{2,5}.1^{7,10}]-3-dodecene and derivatives thereof.

Examples of the substituent in the aforementioned monomer may include: an alkyl group such as a methyl group and an ethyl group; an alkenyl group such as a vinyl group; an alkylidene group such as propane-2-ylidene; an aryl group such as a phenyl group; a hydroxy group; an acid anhydride group; a carboxyl group; and an alkoxycarbonyl group such as a methoxycarbonyl group. As the aforementioned substituent, one type thereof may be solely used, and two or more types thereof may also be used in combination at any ratio.

Examples of the monocyclic olefin may include cyclic monoolefins such as cyclobutene, cyclopentene, methylcyclopentene, cyclohexene, methylcyclohexene, cycloheptene, and cyclooctene; and cyclic diolefins such as cyclohexadiene, methylcyclohexadiene, cyclooctadiene, methylcyclooctadiene, and phenylcyclooctadiene.

As the cyclic olefin monomer, one type thereof may be solely used, and two or more types thereof may also be used in combination at any ratio. When two or more types of the cyclic olefin monomers are used, the polymer (α) may be a block copolymer or a random copolymer.

Some of the cyclic olefin monomers may allow presence of endo- and exo-stereoisomers. As the cyclic olefin monomer, any of the endo- and exo-isomers may be used. One of the endo- and exo-isomers may be solely used, and an isomer mixture containing the endo- and exo-isomers at any ratio may also be used. In particular, it is preferable that the ratio of one of the stereoisomers is at a high level because crystallizability of the alicyclic structure-containing polymer is thereby enhanced and the first layer having excellent flexibility can thereby be easily obtained. For example, the ratio of the endo- or exo-isomer is preferably 80% or more, more preferably 90% or more, further preferably 95% or more, and ideally 100%. It is preferable that the ratio of the endo-isomer is high because it can be easily synthesized.

The crystallizability of the polymer (α) and the polymer (β) can usually be enhanced by increasing the degree of syndiotactic stereoregularity thereof (the ratio of the racemo diad). From the viewpoint of increasing the degree of stereoregularity of the polymer (α) and the polymer (β), the ratio of the racemo diad in the structural units of the polymer (α) and the polymer (β) is preferably 51% or more, more preferably 60% or more, particularly preferably 70% or more, and ideally 100%.

The ratio of the racemo diad may be measured by ¹³C-NMR spectrum analysis. Specifically, the measurement may be performed by the following method.

The ¹³C-NMR measurement of a polymer sample is performed at 200° C. with ortho-dichlorobenzene-d⁴ as a solvent by an inverse-gated decoupling method. From the result of this ¹³C-NMR measurement, a signal at 43.35 ppm attributable to the meso diad and a signal at 43.43 ppm attributable to the racemo diad are identified with the peak at 127.5 ppm of ortho-dichlorobenzene-d⁴ as a reference shift. On the basis of the intensity ratio of these signals, the ratio of the racemo diad of the polymer sample may be determined.

For the synthesis of the polymer (α), a ring-opening polymerization catalyst is usually used. As the ring-opening polymerization catalyst, one type thereof may be solely used, and two or more types thereof may also be used in combination at any ratio. As such a ring-opening polymerization catalyst for synthesis of the polymer (α), a ring-opening polymerization catalyst that can cause ring-opening polymerization of the cyclic olefin monomer to produce a ring-opening polymer having syndiotactic stereoregularity is preferable. Preferable examples of the ring-opening polymerization catalyst may include those including a metal compound represented by the following formula (II):

M(NR¹)X₄₋ₐ(OR²)ₐ·L_{b} (II)

(In the formula (II),

M is a metal atom selected from the group consisting of the Group 6 transition metal atoms in the periodic table,

R¹ is a phenyl group optionally having a substituent at one or more of 3-, 4-, and 5-positions, or a group represented by —CH₂R³ (wherein R³ is a group selected from the group consisting of a hydrogen atom, an alkyl group optionally having a substituent, and an aryl group optionally having a substituent),

R² is a group selected from the group consisting of an alkyl group optionally having a substituent and an aryl group optionally having a substituent,

X is a group selected from the group consisting of a halogen atom, an alkyl group optionally having a substituent, an aryl group optionally having a substituent, and an alkylsilyl group,

L is a neutral electron donor ligand,

a is a number of 0 or 1, and

b is an integer of 0 to 2.)

In the formula (II), M is a metal atom selected from the group consisting of the Group 6 transition metal atoms in the periodic table. M is preferably chromium, molybdenum, or tungsten, more preferably molybdenum or tungsten, and particularly preferably tungsten.

In the formula (II), R¹ is a phenyl group optionally having a substituent at one or more of the 3-, 4-, and 5-positions, or a group represented by —CH₂R³.

The number of carbon atoms of the phenyl group optionally having a substituent at one or more of the 3-, 4-, and 5-positions of R¹ is preferably 6 to 20, and more preferably 6 to 15. Examples of the substituent may include an alkyl group such as a methyl group and an ethyl group; a halogen atom such as a fluorine atom, a chlorine atom, and a bromine atom; and an alkoxy group such as a methoxy group, an ethoxy group, and an isopropoxy group. As these substituents, one type thereof may be solely used, and two or more types thereof may also be used in combination at any ratio. In R¹, the substituents present at two or more of the 3-, 4-, and 5-positions may be bonded to each other, to form a ring structure.

Examples of the phenyl group optionally having a substituent at one or more of the 3-, 4-, and 5-positions may include an unsubstituted phenyl group; a monosubstituted phenyl group such as a 4-methylphenyl group, a 4-chlorophenyl group, a 3-methoxyphenyl group, a 4-cyclohexylphenyl group, and a 4-methoxyphenyl group; a disubstituted phenyl group such as a 3,5-dimethylphenyl group, a 3,5-dichlorophenyl group, a 3,4-dimethylphenyl group, and a 3,5-dimethoxyphenyl group; a trisubstituted phenyl group such as a 3,4,5-trimethylphenyl group, and a 3,4,5-trichlorophenyl group; and a 2-naphthyl group optionally having a substituent such as a 2-naphthyl group, a 3-methyl-2-naphthyl group, and a 4-methyl-2-naphthyl group.

In the group represented by —CH₂R³ of R¹, R³ is a group selected from the group consisting of a hydrogen atom, an alkyl group optionally having a substituent, and an aryl group optionally having a substituent.

The number of carbon atoms in the alkyl group optionally having a substituent of R³ is preferably 1 to 20, and more preferably 1 to 10. This alkyl group may be either linear or branched. Examples of the substituent may include a phenyl group optionally having a substituent such as a phenyl group and a 4-methylphenyl group; and an alkoxyl group such as a methoxy group and an ethoxy group. As the substituent, one type thereof may be solely used, and two or more types thereof may also be used in combination at any ratio.

Examples of the alkyl group optionally having a substituent of R³ may include a methyl group, an ethyl group, a propyl group, an isopropyl group, a butyl group, an isobutyl group, a t-butyl group, a pentyl group, a neopentyl group, a benzyl group, and a neophyl group.

The number of carbon atoms in the aryl group optionally having a substituent of R³ is preferably 6 to 20, and more preferably 6 to 15. Examples of the substituent may include an alkyl group such as a methyl group and an ethyl group; a halogen atom such as a fluorine atom, a chlorine atom, and a bromine atom; and an alkoxy group such as a methoxy group, an ethoxy group, and an isopropoxy group. As the substituent, one type thereof may be solely used, and two or more types thereof may also be used in combination at any ratio.

Examples of the aryl group optionally having a substituent of R³ may include a phenyl group, a 1-naphthyl group, a 2-naphthyl group, a 4-methylphenyl group, and a 2,6-dimethylphenyl group.

Among these, the group represented by R³ is preferably an alkyl group of 1 to 20 carbon atoms.

In the formula (II), R² is a group selected from the group consisting of an alkyl group optionally having a substituent and an aryl group optionally having a substituent. As the alkyl group optionally having a substituent and the aryl group optionally having a substituent of R², a group selected from groups shown as the alkyl groups optionally having a substituent and the aryl groups optionally having a substituent, respectively, of R³ may be optionally used.

In the formula (II), X is a group selected from the group consisting of a halogen atom, an alkyl group optionally having a substituent, an aryl group optionally having a substituent, and an alkylsilyl group.

Examples of the halogen atom of X may include a chlorine atom, a bromine atom, and an iodine atom.

As the alkyl group optionally having a substituent and the aryl group optionally having a substituent of X, a group selected from groups shown as the alkyl groups optionally having a substituent and the aryl groups optionally having a substituent, respectively, of R³ may be optionally used.

Examples of the alkylsilyl group of X may include a trimethylsilyl group, a triethylsilyl group, and a t-butyldimethylsilyl group.

When the metal compound represented by the formula (II) has two or more X's in one molecule, the X's may be the same as or different from each other. Further, the two or more X's may be bonded to each other to form a ring structure.

In the formula (II), L is a neutral electron donor ligand.

Examples of the neutral electron donor ligand of L may include an electron donor compound containing an atom of the Group 14 or 15 in the periodic table. Specific examples thereof may include phosphines such as trimethylphosphine, triisopropylphosphine, tricyclohexylphosphine, and triphenylphosphine; ethers such as diethyl ether, dibutyl ether, 1,2-dimethoxyethane, and tetrahydrofuran; and amines such as trimethylamine, triethylamine, pyridine, and lutidine. Among these, ethers are preferable. When the metal compound represented by the formula (II) has two or more L's in one molecule, the L's may be the same as or different from each other.

The metal compound represented by the formula (II) is preferably a tungsten compound having a phenylimido group. That is, a metal compound represented by the formula (II) wherein M is a tungsten atom and R¹ is a phenyl group is preferable. In particular, a tetrachlorotungsten phenylimide (tetrahydrofuran) complex is more preferable.

The method for producing the metal compound represented by the formula (II) is not particularly limited. For example, as described in Japanese Patent Application Laid-Open No. Hei. 5-345817 A, the metal compound represented by the formula (II) may be produced by mixing an oxyhalogenated product of a Group 6 transition metal; a phenyl isocyanate optionally having a substituent at one or more of the 3-, 4-, and 5-positions or a monosubstituted methyl isocyanate; a neutral electron donor ligand (L); and if necessary, an alcohol, a metal alkoxide, and a metal aryloxide.

In the aforementioned production method, the metal compound represented by the formula (II) is usually obtained in a state where the compound is contained in a reaction liquid. After the production of the metal compound, the aforementioned reaction liquid as it is may be used as a catalyst liquid for the ring-opening polymerization reaction. Alternatively, the metal compound may be isolated from the reaction liquid and purified by a purification treatment such as crystallization, and the resulting metal compound may be used for the ring-opening polymerization reaction.

As the ring-opening polymerization catalyst, the metal compound represented by the formula (II) may be solely used. Alternatively, the metal compound represented by the formula (II) may be used in combination with another component. For example, the metal compound represented by the formula (II) may be used in combination with an organometallic reductant, to improve polymerization activity.

Examples of the organometallic reductant may include organometallic compounds of Groups 1, 2, 12, 13, and 14 in the periodic table, having a hydrocarbon group of 1 to 20 carbon atoms. Examples of such organometallic compounds may include an organolithium such as methyllithium, n-butyllithium, and phenyllithium; an organomagnesium such as butylethylmagnesium, butyloctylmagnesium, dihexylmagnesium, ethylmagnesium chloride, n-butylmagnesium chloride, and allylmagnesium bromide; an organozinc such as dimethylzinc, diethylzinc, and diphenylzinc; an organoaluminum such as trimethylaluminum, triethylaluminum, triisobutylaluminum, diethylaluminum chloride, ethylaluminum sesquichloride, ethylaluminum dichloride, diethylaluminum ethoxide, diisobutylaluminum isobutoxide, ethylaluminum diethoxide, and isobutylaluminum diisobutoxide; and an organotin such as tetramethyltin, tetra(n-butyl)tin, and tetraphenyltin. Among these, an organoaluminum and an organotin are preferable. As the organometallic reductant, one type thereof may be solely used, and two or more types thereof may also be used in combination at any ratio.

The ring-opening polymerization reaction is usually performed in an organic solvent. As the organic solvent, an organic solvent that allows the ring-opening polymer and a hydrogenated product thereof to be dissolved or dispersed under specific conditions and does not inhibit the ring-opening polymerization reaction and a hydrogenation reaction may be used. Examples of such an organic solvent may include aliphatic hydrocarbons such as pentane, hexane, and heptane; alicyclic hydrocarbons such as cyclopentane, cyclohexane, methylcyclohexane, dimethylcyclohexane, trimethylcyclohexane, ethylcyclohexane, diethylcyclohexane, decahydronaphthalene, bicycloheptane, tricyclodecane, hexahydroindene, and cyclooctane; aromatic hydrocarbons such as benzene, toluene, and xylene; halogenated aliphatic hydrocarbons such as dichloromethane, chloroform, and 1,2-dichloroethane; halogenated aromatic hydrocarbons such as chlorobenzene and dichlorobenzene; nitrogen-containing hydrocarbons such as nitromethane, nitrobenzene, and acetonitrile; ethers such as diethyl ether and tetrahydrofuran; and mixed solvents obtained by a combination thereof. Among these, aromatic hydrocarbons, aliphatic hydrocarbons, alicyclic hydrocarbons, and ethers are preferable as the organic solvent. As the organic solvent, one type thereof may be solely used, and two or more types thereof may also be used in combination at any ratio.

The ring-opening polymerization reaction may be initiated by, for example, mixing the cyclic olefin monomer, the metal compound represented by the formula (II), and if necessary, the organometallic reductant. The order of mixing these components is not particularly limited. For example, a solution containing the metal compound represented by the formula (II) and the organometallic reductant may be mixed in a solution containing the cyclic olefin monomer. Alternatively, a solution containing the cyclic olefin monomer and the metal compound represented by the formula (II) may be mixed in a solution containing the organometallic reductant. Further, a solution containing the metal compound represented by the formula (II) may be mixed in a solution containing the cyclic olefin monomer and the organometallic reductant. When the respective components are mixed, the total amount of each of the components may be mixed at once, or the components may be mixed in a plurality of batches. The components may also be continuously mixed over a relatively long period of time (for example, 1 minute or more).

The concentration of the cyclic olefin monomer in the reaction liquid at the time of starting the ring-opening polymerization reaction is preferably 1% by weight or more, more preferably 2% by weight or more, and particularly preferably 3% by weight or more, and is preferably 50% by weight or less, more preferably 45% by weight or less, and particularly preferably 40% by weight or less. When the concentration of the cyclic olefin monomer is equal to or more than the lower limit value of the aforementioned range, productivity can be enhanced. When the concentration thereof is equal to or less than the upper limit value, viscosity of the reaction liquid after the ring-opening polymerization reaction can be decreased. Consequently, the subsequent hydrogenation reaction can be facilitated.

The amount of the metal compound represented by the formula (II) used in the ring-opening polymerization reaction is desirably set so that the molar ratio of “metal compound:cyclic olefin monomer” falls within a specific range. Specifically, the aforementioned molar ratio is preferably 1:100 to 1:2,000,000, more preferably 1:500 to 1,000,000, and particularly preferably 1:1,000 to 1:500,000. When the amount of the metal compound is equal to or more than the lower limit value of the aforementioned range, sufficient polymerization activity can be obtained. When the amount thereof is equal to or less than the upper limit value, the metal compound can be easily removed after the reaction.

The amount of the organometallic reductant is preferably 0.1 mol or more, more preferably 0.2 mol or more, and particularly preferably 0.5 mol or more, and is preferably 100 mol or less, more preferably 50 mol or less, and particularly preferably 20 mol or less, relative to 1 mol of the metal compound represented by the formula (II). When the amount of the organometallic reductant is equal to or more than the lower limit value of the aforementioned range, polymerization activity can be sufficiently enhanced. When the amount thereof is equal to or less than the upper limit value, occurrence of a side reaction can be suppressed.

The polymerization reaction system of the polymer (α) may contain an activity adjuster. When the activity adjuster is used, the ring-opening polymerization catalyst can be stabilized, the reaction speed of the ring-opening polymerization reaction can be adjusted, and the molecular weight distribution of the polymer can be adjusted.

As the activity adjuster, an organic compound having a functional group may be used. Examples of the activity adjuster may include an oxygen-containing compound, a nitrogen-containing compound, and a phosphorus-containing organic compound.

Examples of the oxygen-containing compound may include: ethers such as diethyl ether, diisopropyl ether, dibutyl ether, anisole, furan, and tetrahydrofuran; ketones such as acetone, benzophenone, and cyclohexanone; and esters such as ethyl acetate.

Examples of the nitrogen-containing compound may include: nitriles such as acetonitrile and benzonitrile; amines such as triethylamine, triisopropylamine, quinuclidine, and N,N-diethylaniline; and pyridines such as pyridine, 2,4-lutidine, 2,6-lutidine, and 2-t-butylpyridine.

Examples of the phosphorous-containing compound may include: phosphines such as triphenyl phosphine, tricyclohexyl phosphine, triphenyl phosphate, and trimethyl phosphate; and phosphine oxides such as triphenyl phosphine oxide.

As the activity adjuster, one type thereof may be solely used, and two or more types thereof may also be used in combination at any ratio.

The amount of the activity adjuster in the polymerization reaction system of the polymer (α) is preferably 0.01 mol % to 100 mol % relative to 100 mol % of the metal compound represented by the formula (II).

In order to adjust the molecular weight of the polymer (α), the polymerization reaction system of the polymer (α) may contain a molecular weight adjuster. Examples of the molecular weight adjuster may include: α-olefins such as 1-butene, 1-pentene, 1-hexene, and 1-octene; aromatic vinyl compounds such as styrene and vinyltoluene; an oxygen-containing vinyl compound such as ethyl vinyl ether, isobutyl vinyl ether, allyl glycidyl ether, allyl acetate, allyl alcohol, and glycidyl methacrylate; a halogen-containing vinyl compound such as allyl chloride; a nitrogen-containing vinyl compound such as acrylamide; non-conjugated dienes such as 1,4-pentadiene, 1,4-hexadiene, 1,5-hexadiene, 1,6-heptadiene, 2-methyl-1,4-pentadiene, and 2,5-dimethyl-1,5-hexadiene; and conjugated dienes such as 1,3-butadiene, 2-methyl-1,3-butadiene, 2,3-dimethyl-1,3-butadiene, 1,3-pentadiene, and 1,3-hexadiene.

As the molecular weight adjuster, one type thereof may be solely used, and two or more types thereof may also be used in combination at any ratio.

The amount of the molecular weight adjuster in the polymerization reaction system for polymerizing the polymer (α) may be appropriately determined depending on an intended molecular weight. The specific amount of the molecular weight adjuster is preferably in a range of 0.1 mol % to 50 mol % relative to the cyclic olefin monomer.

The polymerization temperature is preferably −78° C. or higher, and more preferably −30° C. or higher, and is preferably +200° C. or lower, and more preferably +180° C. or lower.

The polymerization time may be dependent on reaction scale. The specific polymerization time is preferably in a range of 1 minute to 1,000 hours.

By the aforementioned production method, the polymer (α) may be obtained. By hydrogenating this polymer (α), the polymer (β) may be produced.

For example, the polymer (α) may be hydrogenated by supplying hydrogen into the reaction system containing the polymer (α) in the presence of a hydrogenation catalyst in accordance with an ordinary method. When reaction conditions in this hydrogenation reaction are appropriately set, the tacticity of the hydrogenated product is not usually altered by the hydrogenation reaction.

As the hydrogenation catalyst, a homogeneous catalyst or a heterogeneous catalyst that is publicly known as a hydrogenation catalyst for an olefin compound may be used.

Examples of the homogeneous catalyst may include a catalyst including a combination of a transition metal compound and an alkali metal compound such as cobalt acetate/triethylaluminum, nickel acetylacetonate/triisobutylaluminum, titanocene dichloride/n-butyllithium, zirconocene dichloride/sec-butyllithium, and tetrabutoxy titanate/dimethylmagnesium; and a noble metal complex catalyst such as dichlorobis(triphenylphosphine)palladium, chlorohydridecarbonyltris(triphenylphosphine)ruthenium, chlorohydridecarbonylbis(tricyclohexylphosphine)ruthenium, bis(tricyclohexylphosphine)benzylidyne ruthenium (IV) dichloride, and chlorotris(triphenylphosphine)rhodium.

Examples of the heterogeneous catalyst may include a metal catalyst such as nickel, palladium, platinum, rhodium, and ruthenium; and a solid catalyst in which the aforementioned metal is supported on a carrier such as carbon, silica, diatomaceous earth, alumina, or titanium oxide such as nickel/silica, nickel/diatomaceous earth, nickel/alumina, palladium/carbon, palladium/silica, palladium/diatomaceous earth, and palladium/alumina.

As the hydrogenation catalyst, one type thereof may be solely used, and two or more types thereof may also be used in combination at any ratio.

The hydrogenation reaction is usually performed in an inert organic solvent. Examples of the inert organic solvent may include: aromatic hydrocarbons such as benzene and toluene; aliphatic hydrocarbons such as pentane and hexane; alicyclic hydrocarbons such as cyclohexane and decahydronaphthalene; and ethers such as tetrahydrofuran and ethylene glycol dimethyl ether. As the inert organic solvent, one type thereof may be solely used, and two or more types thereof may also be used in combination at any ratio. The inert organic solvent may be the same as or different from the organic solvent used in the ring-opening polymerization reaction. Furthermore, the hydrogenation catalyst may be mixed in the reaction liquid of the ring-opening polymerization reaction for performing the hydrogenation reaction.

The reaction conditions for the hydrogenation reaction usually vary also depending on the hydrogenation catalyst used.

The reaction temperature of the hydrogenation reaction is preferably −20° C. or higher, more preferably −10° C. or higher, and particularly preferably 0° C. or higher, and is preferably +250° C. or lower, more preferably +220° C. or lower, and particularly preferably +200° C. or lower. When the reaction temperature is equal to or higher than the lower limit value of the aforementioned range, reaction speed can be increased. When the reaction temperature is equal to or lower than the upper limit value, occurrence of a side reaction can be suppressed.

The hydrogen pressure is preferably 0.01 MPa or more, more preferably 0.05 MPa or more, and particularly preferably 0.1 MPa or more, and is preferably 20 MPa or less, more preferably 15 MPa or less, and particularly preferably 10 MPa or less. When the hydrogen pressure is equal to or more than the lower limit value of the aforementioned range, the reaction speed can be increased. When the hydrogen pressure is equal to or less than the upper limit value, a special apparatus such as a high pressure resistant reaction apparatus is not required, and thereby facility costs can be reduced.

The reaction time of the hydrogenation reaction may be set to any time period during which a desired hydrogenation rate is achieved, and preferably 0.1 hour to 10 hours.

After the hydrogenation reaction, the polymer (β), which is the hydrogenated product of the polymer (α), is usually collected in accordance with an ordinary method.

The hydrogenation rate (the ratio of the hydrogenated main-chain double bond) in the hydrogenation reaction is preferably 98% or more, and more preferably 99% or more. As the hydrogenation rate becomes higher, flexibility of the alicyclic structure-containing polymer can be made more favorable.

Herein, the hydrogenation rate of the polymer may be measured by a ¹H-NMR measurement at 145° C. with o-dichlorobenzene-d⁴ as a solvent.

Subsequently, the methods for producing the polymer (γ) and the polymer (δ) will be described.

The cyclic olefin monomer to be used for producing the polymer (γ) and the polymer (δ) may be optionally selected from the range shown as the cyclic olefin monomers to be used for producing the polymer (α) and the polymer (β). As the cyclic olefin monomer, one type thereof may be solely used, and two or more types thereof may also be used in combination at any ratio.

In the production of the polymer (γ), an optional monomer which is copolymerizable with a cyclic olefin monomer may be used as a monomer in combination with the cyclic olefin monomer. Examples of the optional monomer may include: α-olefins of 2 to 20 carbon atoms such as ethylene, propylene, 1-butene, 1-pentene, and 1-hexene; an aromatic ring vinyl compound such as styrene and α-methylstyrene; and non-conjugated dienes such as 1,4-hexadiene, 4-methyl-1,4-hexadiene, 5-methyl-1,4-hexadiene, and 1,7-octadiene. Among these, an α-olefin is preferable, and ethylene is more preferable. As the optional monomer, one type thereof may be solely used, and two or more types thereof may also be used in combination at any ratio.

The ratio between the cyclic olefin monomer and the optional monomer in terms of a weight ratio (cyclic olefin monomer:optional monomer) is preferably 30:70 to 99:1, more preferably 50:50 to 97:3, and particularly preferably 70:30 to 95:5.

When two or more types of the cyclic olefin monomers are used, or when the cyclic olefin monomer and the optional monomer are used in combination, the polymer (γ) may be a block copolymer, or a random copolymer.

For the synthesis of the polymer (γ), an addition polymerization catalyst is usually used. Examples of the addition polymerization catalyst may include a vanadium-based catalyst formed from a vanadium compound and an organoaluminum compound, a titanium-based catalyst formed from a titanium compound and an organoaluminum compound, and a zirconium-based catalyst formed from a zirconium complex and aluminoxane. As the addition polymerization catalyst, one type thereof may be solely used, and two or more types thereof may also be used in combination at any ratio.

The amount of the addition polymerization catalyst is preferably 0.000001 mol or more, and more preferably 0.00001 mol or more, and is preferably 0.1 mol or less, and more preferably 0.01 mol or less, relative to 1 mol of a monomer.

The addition polymerization of the cyclic olefin monomer is usually performed in an organic solvent. The organic solvent may be optionally selected from the range shown as the organic solvents to be used for the ring-opening polymerization of a cyclic olefin monomer. As the organic solvent, one type thereof may be solely used, and two or more types thereof may also be used in combination at any ratio.

The polymerization temperature in the polymerization for producing the polymer (γ) is preferably −50° C. or higher, more preferably −30° C. or higher, and particularly preferably −20° C. or higher, and is preferably 250° C. or lower, more preferably 200° C. or lower, and particularly preferably 150° C. or lower. The polymerization time is preferably 30 minutes or more, and more preferably 1 hour or more, and is preferably 20 hours or less, and more preferably 10 hours or less.

By the aforementioned production method, the polymer (γ) may be obtained. By hydrogenating this polymer (γ), the polymer (δ) may be produced.

The hydrogenation of the polymer (γ) may be performed by a similar method to the method previously described as the method for hydrogenating the polymer (α).

In the crystallizable resin, the ratio of the alicyclic structure-containing polymer having crystallizability is preferably 50% by weight or more, more preferably 70% by weight or more, and particularly preferably 90% by weight or more. When the ratio of the alicyclic structure-containing polymer having crystallizability is equal to or more than the lower limit value of the aforementioned range, flexibility of the first layer can be enhanced.

The crystallizable resin may contain an optional component in addition to the alicyclic structure-containing polymer having crystallizability. Examples of the optional components may include an antioxidant such as a phenol-based antioxidant, a phosphorus-based antioxidant, and a sulfur-based antioxidant; a light stabilizer such as a hindered amine-based light stabilizer; a wax such as a petroleum-based wax, a Fischer-Tropsch wax, and a polyalkylene wax; a nucleating agent such as a sorbitol-based compound, a metal salt of an organic phosphoric acid, a metal salt of an organic carboxylic acid, kaolin, and talc; a fluorescent brightener such as a diaminostilbene derivative, a coumarin derivative, an azole-based derivative (for example, a benzoxazole derivative, a benzotriazole derivative, a benzimidazole derivative, and a benzothiazole derivative), a carbazole derivative, a pyridine derivative, a naphthalic acid derivative, and an imidazolone derivative; an ultraviolet absorber such as a benzophenone-based ultraviolet absorber, a salicylic acid-based ultraviolet absorber, and a benzotriazole-based ultraviolet absorber; an inorganic filler such as talc, silica, calcium carbonate, and glass fiber; a colorant; a flame retardant; a flame retardant auxiliary; an antistatic agent; a plasticizer; a near-infrared absorber; a lubricant; a filler, and an optional polymer other than the alicyclic structure-containing polymer having crystallizability such as a soft polymer. As the optional component, one type thereof may be solely used, and two or more types thereof may also be used in combination at any ratio.

The layer of the crystallized resin preferably has a small haze. Specifically, the haze is preferably less than 3.0%, more preferably less than 2%, particularly preferably less than 1%, and ideally 0%. A resin film with small haze as described above can be suitably used as an optical film. Usually, the easy-adhesion layer incurs almost no haze increase, and therefore the haze of the optical film formed of the first layer and the easy-adhesion layer can be regarded as being equal to the haze of the layer of the crystallized resin.

The haze may be measured by cutting a layer of the crystallized resin with the central portion thereof being the center of a 50 mm×50 mm square shape to obtain a sample, and measuring the haze thereof using a haze meter.

The layer of the crystallized resin is usually excellent in heat resistance. Specifically, the heat resistance temperature of the layer of the crystallized resin is usually 150° C. or higher. The resin layer having such a high heat resistance temperature can be suitably used in use applications requiring heat resistance such as a resin film for vehicles, for example.

The heat resistance temperature may be measured by the following method. Without applying a tensile force to the layer of the crystallized resin, the layer of the crystallized resin is left in an atmosphere of a certain evaluation temperature for 10 minutes. After that, the surface state of the layer of the crystallized resin is visually checked. When irregularities cannot be confirmed on the surface shape of the layer of the crystallized resin, it can be determined that the heat resistance temperature of the layer of the crystallized resin is equal to or higher than the above-mentioned evaluation temperature.

It is preferable that the layer of the crystallized resin has high total light transmittance. Specifically, the total light transmittance of the layer of the crystallized resin is preferably 80% or more, more preferably 85% or more, and particularly preferably 88% or more. The total light transmittance thereof may be measured in the wavelength range of 400 nm to 700 nm using an ultraviolet-visible spectrometer.

Further, the layer of the crystallized resin is preferably excellent in folding resistance. The folding resistance of the layer of the crystallized resin is specifically represented by a folding endurance. The folding endurance descried above is preferably 2,000 times or more, more preferably 2,200 times or more, particularly preferably 2,400 times or more. The upper limit of the folding endurance is not limited as the higher folding endurance is more preferable. However, the folding endurance is usually 100,000 times or less.

The folding endurance of the layer of the crystallized resin may be measured by the following method using an MIT folding test in accordance with JIS P 8115 “Paper and Board—Determination of Folding Endurance—MIT Method”.

From the film of the crystallized resin as a sample, a test piece having a width of 15 mm±0.1 mm and a length of about 110 mm is cut out. In this process, the test piece is produced such that a direction in which the resin film is more strongly stretched is parallel to the edge of the length of about 110 mm of the test piece. The aforementioned test piece is then bent by using an MIT folding endurance tester (“No. 307” manufactured by Yasuda Seiki Seisakusho, Ltd.) under conditions of a load of 9.8 N, a curvature of bending portion of 0.38±0.02 mm, a bending angle of 135°±2°, and a bending speed of 175 times/min such that a folding line appears in the width direction of the test piece. The bending is repeated and the number of reciprocating bending times until the test piece is ruptured is measured.

Ten test pieces are produced and the number of reciprocating bending times until the test piece is ruptured is measured ten times by the method described above. The average of ten measurement values measured in this manner is adopted as the folding endurance (the MIT fold number) of the crystallized resin film.

The layer of the crystallized resin is usually excellent in low water absorption. Specifically, the low water absorption of the layer of the crystallized resin may be expressed by water absorption rate. The water absorption rate thereof is usually 0.1% or less, preferably 0.08% or less, and more preferably 0.05% or less.

The water absorption rate of the layer of the crystallized resin may be measured by the following method.

A test piece is cut out from a film of the crystallized resin as a sample, and the weight of the test piece is measured. After that, the test piece is immersed in water at 23° C. for 24 hours, and the weight of the test piece after immersion is measured. Then, the ratio of the weight of the test piece increased by immersion to the weight of the test piece before immersion may be calculated as the water absorption rate (%).

The residual solvent amount of the layer of the crystallized resin is 1.0% by weight or less, more preferably 0.5% by weight or less, and further preferably 0.1% by weight or less. When the residual solvent amount is at this desired value, curling amount of the layer of the crystallized resin can be suppressed. The residual solvent amount may be usually obtained by gas chromatography.

[3. Easy-Adhesion Layer]

The easy-adhesion layer is a layer of a urethane resin. The urethane resin is a resin that includes a polyurethane or a reaction product thereof. The urethane resin is preferably a crosslinked product obtained by a reaction between the polyurethane and a crosslinking agent. The easy-adhesion layer is usually in direct contact with the first layer. That is, usually, no other layers are interposed between the first layer and the easy-adhesion layer. However, if necessary, an optional layer may be interposed between the first layer and the easy-adhesion layer as long as the effects of the present invention are not significantly impaired.

Examples of the polyurethane may include polyurethanes derived from various polyols and polyisocyanates. Examples of the polyol may include aliphatic polyester-based polyols obtained by reaction between a polyol compound (ethylene glycol, propylene glycol, 1,4-butanediol, neopentyl glycol, glycerin, trimethylolpropane, etc.) and a polybasic acid (polycarboxylic acid (for example, dicarboxylic acid such as adipic acid, succinic acid, sebacic acid, glutaric acid, maleic acid, fumaric acid, phthalic acid, isophthalic acid, terephthalic acid, and polycarboxylic acid containing tricarboxylic acid such as trimellitic acid or an anhydride thereof), any one of polyether polyol (for example, poly(oxypropylene ether)polyol, poly(oxyethylene-propylene ether)polyol), polycarbonate-based polyol, and polyethylene terephthalate polyol, and mixtures thereof. In the polyurethane, for example, a hydroxyl group remaining as an unreacted group after the reaction between the polyol and the polyisocyanate can be utilized as a polar group capable of crosslinking reaction with a functional group in the crosslinking agent. As the polyurethane, a polycarbonate-based polyurethane having a carbonate structure in its skeleton is preferable.

As the polyurethane, polyurethanes included in an aqueous emulsion that is commercially available as a water-based urethane resin may be used. The water-based urethane resin is a composition including the polyurethane and water. In the water-based urethane resin, the polyurethane and an optional component included if necessary are usually dispersed in water. Examples of the water-based urethane resin to be used may include “ADEKA BONTIGHTER” series manufactured by Adeka Corp., “OLESTER” series manufactured by Mitsui Chemicals, Inc., “VONDIC” series and “HYDRAN (such as WLS201 and WLS202)” series manufactured by DIC Corp., “Impranil” series manufactured by Bayer Material Science, “POIZ” series manufactured by Kao Corp., “SANPRENE” series manufactured by Sanyo Chemical Industries, Ltd., “SUPERFLEX” series manufactured by DKS Co., Ltd., “NeoRez” series manufactured by Kusumoto Chemicals, Ltd., and “Sancure” series manufactured by Lubrizol Corp. As the polyurethane, one type thereof may be solely used, and two or more types thereof may also be used in combination at any ratio.

The cross-linking agent may be a compound having two or more functional groups in the molecule that can react with the functional group (polar group) in the various polyurethanes described above to form a bond. Examples of the crosslinking agent may include an epoxy compound, a carbodiimide compound, an oxazoline compound, and an isocyanate compound, and an epoxy compound is preferable.

As the epoxy compound, a polyfunctional epoxy compound having two or more epoxy groups in its molecule may be used. Use of such a compound can promote the cross-linking reaction to effectively improve the mechanical strength of the easy-adhesion layer.

As the epoxy compound, those which are soluble in water or can be dispersed in water to be emulsified are preferable from the viewpoint of ease of use. Examples of epoxy compounds may include diepoxy compounds obtained by etherification of 1 mole of glycols such as ethylene glycol, diethylene glycol, triethylene glycol, polyethylene glycol, propylene glycol, dipropylene glycol, 1,4-butanediol, 1,6-hexane glycol, and neopentyl glycol, and 2 moles of epichlorohydrin; polyepoxy compounds obtained by etherification of 1 mole of polyhydric alcohols such as glycerin, polyglycerin, trimethylolpropane, pentaerythritol, and sorbitol, and 2 moles or more of epichlorohydrin; and diepoxy compounds obtained by esterification of 1 mole of dicarboxylic acids such as phthalic acid, terephthalic acid, oxalic acid, and adipic acid, and 2 moles of epichlorohydrin. As the epoxy compound, one type thereof may be solely used, and two or more types thereof may also be used in combination at any ratio.

More specifically, preferable examples of the epoxy compounds may include 1,4-bis(2′,3′-epoxypropyloxy)butane, 1,3,5-triglycidyl isocyanurate, 1,3-diglycidyl-5-(γ-acetoxy-β-oxypropyl) isocyanurate, sorbitol polyglycidyl ethers, polyglycerol polyglycidylethers, pentaerythritol polyglycidylethers, diglycerol polyglycidylethers, 1,3,5-triglycidyl(2-hydroxyethyl)isocyanurate, glycerol polyglycerol ethers, and trimethylolpropane polyglycidylethers. Examples of specific commercially available products thereof may include “Denacol (Denacol EX-521, EX-614B)” series manufactured by Nagase ChemteX Corporation.

The easy-adhesion layer may be formed by using a material Y that includes a polyurethane and/or its precursor. In the present application, the easy-adhesion layer being “formed by using” the material Y means that the easy-adhesion layer is formed by a layer forming process using the material Y as a material. As a result of such a forming process, the material Y as it is turns into the easy-adhesion layer. Alternatively, if necessary, the material Y is subjected to a reaction of its component, volatilization of its solvent, and the like, to be the easy-adhesion layer. For example, the material Y is a solution or a dispersion including a polyurethane, a crosslinking agent, and a volatile medium such as water, and the easy-adhesion layer is formed by volatilization of the medium and a crosslinking reaction between the polyurethane and the crosslinking agent.

Examples of the polyurethane that the material Y may contain may include the various types of polyurethanes described above. As the precursor of the polyurethane that the material Y may contain, the precursors which can yield the various types of polyurethanes described above may be mentioned. The material Y usually includes the polyurethane and/or its precursor as a main component. The amount of the polyurethane and/or its precursor may be set to preferably 60 to 100% by weight, more preferably 70 to 100% by weight, relative to 100% by weight of the total solid content in the material Y.

The material Y may also include a cross-linking agent. Examples of the crosslinking agent may include the various crosslinking agents described above. When, for example, an epoxy compound is used as the crosslinking agent, the amount thereof is usually 0.1 part by weight or more, preferably 1 part by weight or more, and more preferably 2 parts by weight or more, and is usually 20 parts by weight or less, preferably 15 parts by weight or less, and more preferably 10 parts by weight or less, relative to 100 parts by weight of the total amount of the polyurethane and/or its precursor. When the amount of the epoxy compound is at the lower limit value or more in the aforementioned range, the reaction between the epoxy compound and the polyurethane or the like sufficiently proceeds, and thereby the mechanical strength of the easy-adhesion layer can be appropriately improved. When the amount of the epoxy compound is at the upper limit value or less, the residues of the unreacted epoxy compound can be reduced, so that mechanical strength of the easy-adhesion layer can be appropriately improved.

The material Y may also include a curing accelerator, a curing aid, and the like. When an epoxy compound is used as a crosslinking agent, a tertiary amine-based compound (excluding a compound having a 2,2,6,6-tetramethylpiperidyl group having a tertiary amine at the 4-position) or a boron trifluoride complex compound, etc. may be preferably used as a curing accelerator. As the curing accelerator, one type thereof may be solely used, and two or more types thereof may also be used in combination at any ratio. The adding amount of the curing accelerator may be appropriately selected depending on the purpose of use. For example, the amount is usually 0.001 to 30 parts by weight, preferably 0.01 to 20 parts by weight, and more preferably 0.03 to 10 parts by weight, relative to 100 parts by weight of the polyurethane having a functional group and/or the precursor thereof.

Examples of the curing aids may include an oxime.nitroso-based curing aid such as quinone dioxime, benzoquinone dioxime, and p-nitrosophenol; a maleimide-based curing aid such as N,N-m-phenylene bismaleimide; an allyl-based curing aid such as diallyl phthalate, triallyl cyanurate, and triallyl isocyanurate; a methacrylate-based curing aid such as ethylene glycol dimethacrylate, and trimethylol propane trimethacrylate; and a vinyl-based curing aid such as vinyltoluene, ethylvinylbenzene, and divinylbenzene. As the curing aid, one type thereof may be solely used, and two or more types thereof may also be used in combination at any ratio. The adding amount of the curing aid is usually in the range of 1 to 100 parts by weight, and preferably 10 to 50 parts by weight, relative to 100 parts by weight of the crosslinking agent.

The material Y usually includes water or a water-soluble solvent. Examples of the water-soluble solvents may include methanol, ethanol, isopropyl alcohol, acetone, tetrahydrofuran, N-methylpyrrolidone, dimethylsulfoxide, ethylene glycol monomethyl ether, ethylene glycol monobutyl ether, methyl ethyl ketone, and triethylamine. As the solvent, water is preferably used. As the solvent, one type thereof may be solely used, and two or more types thereof may also be used in combination at any ratio. The amount of the solvent to be mixed is preferably set so that the viscosity of the material Y falls within a range suitable for application.

The material Y may include an organic solvent, but is preferably an aqueous emulsion substantially containing no organic solvent. Specifically, the content of the organic solvent may be less than 1% by weight. Herein, examples of the organic solvents may include methyl ethyl ketone, N-methyl-2-pyrrolidone, and butyl cellosolve.

In addition, the material Y may contain any component other than those described above, as long as the advantageous effects of the present invention is not significantly impaired. For example, particulates, a heat-resistant stabilizer, a weather-resistant stabilizer, a leveling agent, a surfactant, an antioxidant, an antistatic agent, a slip agent, an antiblocking agent, an antifog additive, a lubricant, a dye, a pigment, a natural oil, a synthetic oil, a wax, and the like may be included. As each of these components, one type thereof may be solely used, and two or more types thereof may also be used in combination at any ratio.

[4. Thickness of Each Layer]

The thickness of the first layer is preferably 5 μm or more, more preferably 10 μm or more, and particularly preferably 15 μm or more, and is preferably 100 μm or less, more preferably 75 μm or less, and particularly preferably 50 μm or less. When the thickness of the first layer is set to the lower limit value or more, mechanical strength of the optical film can be increased. When the thickness of the first layer is the upper limit value or less, thickness of the optical film can be reduced.

The thickness of the easy-adhesion layer is preferably 100 nm or more, more preferably 200 nm or more, and still more preferably 300 nm or more, and is preferably 5 μm or less, more preferably 2 μm or less, and still more preferably 1 μm or less. When the thickness of the easy-adhesion layer is set to the above-mentioned lower limit value or more, a sufficient peel strength can be obtained. When the thickness of the easy-adhesion layer is set to the above-mentioned upper limit value or more, occurrence of deformation of the easy-adhesion layer which is a relatively soft layer is suppressed, and the multilayer film can be easily wound up as a long-length roll. When the thickness of the easy-adhesion layer falls within the above range, sufficient peel strength between the first layer and the easy-adhesion layer can be obtained, and the thickness of the multilayer film can be reduced.

[5. Method for Producing Optical Film]

The optical film of the present invention may be produced by a production method including the following steps (1), (2), and (4). Hereinafter, this production method will be described as a method for producing the optical film of the present invention. The method for producing the optical film of the present invention may include the following step (3) in addition to the steps (1), (2), and (4).

Step (1): a step of molding a crystallizable resin including an alicyclic structure-containing polymer to obtain a crystallizable resin film having a crystallization degree of less than 3%.

Step (2): a step of forming an easy-adhesion layer on the surface of the crystallizable resin film to obtain a multilayer product including the crystallizable resin film and the easy-adhesion layer.

Step (3): a step of stretching the crystallizable resin film.

Step (4): a step of crystallizing the crystallizable resin film in the multilayer product.

[5.1. Step (1)]

The step (1) may be performed by molding a crystallizable resin including an alicyclic structure-containing polymer by any molding method. Examples of the molding methods may include an injection molding method, a melt extrusion molding method, a press molding method, an inflation molding method, a blow molding method, a calendar molding method, a cast molding method, and a compression molding method. Among these, the melt extrusion molding method is preferable because thereby thickness can be easily controlled.

When the crystallizable resin film is produced by the melt extrusion molding method, the conditions for the extrusion molding are preferably as follows. The cylinder temperature (melted resin temperature) is preferably Tm or higher, and more preferably Tm+20° C. or higher, and is preferably Tm+100° C. or lower, and more preferably Tm+50° C. or lower. The casting roll temperature is preferably Tg−30° C. or higher, and is preferably Tg or lower, and more preferably Tg−15° C. or lower. When the crystallizable resin film is produced under such conditions, the crystallizable resin film having a preferable thickness can be easily produced. Herein, “Tm” represents the melting point of the alicyclic structure-containing polymer, and “Tg” represents the glass transition temperature of the alicyclic structure-containing polymer. By performing molding in accordance with the usual conditions for the melt extrusion molding method, the crystallization degree of the film can be made as low as less than 3%. The crystallization degree is preferably less than 1%, and ideally 0%.

[5.2. Step (2)]

The step (2) may be performed by applying the material Y onto the crystallizable resin film and curing the applied material Y. Examples of specific application methods may include a wire bar coating method, a dipping method, a spraying method, a spin coating method, a roll coating method, a gravure coating method, an air knife coating method, a curtain coating method, a slide coating method, and an extrusion coating method.

When the material Y contains a solvent, the solvent may be removed by drying the material Y at the time of curing. The drying method is optionally selected and may be any method such as reduced pressure drying, heat drying and the like. In particular, from the viewpoint of accelerating progression of a reaction such as a crosslinking reaction in the material Y together with drying, it is preferable to cure the material Y by heat drying. In the case of curing the material Y by heating, the heating temperature may be appropriately set within a range where the material Y can be dried to remove the solvent and simultaneously the resin component in the material Y can be cured.

[5.3. Step (3)]

In the step (3), the crystallizable resin film is stretched. The step (3) may be performed at any stage prior to the step (4). The step (3) may be performed, for example, after the step (2) or simultaneously with the step (2). When the step (3) is performed after the step (2), the multilayer product including the crystallizable resin film and the easy-adhesion layer is stretched in the step (3).

The stretching method for the crystallizable resin film is not particularly limited, and any stretching method may be adopted. Examples of the stretching method may include a uniaxial stretching method such as a method of uniaxially stretching the crystallizable resin film in a lengthwise direction (longitudinal uniaxial stretching method) and a method of uniaxially stretching the crystallizable resin film in a width direction (transversal uniaxial stretching method); a biaxial stretching method such as a simultaneous biaxial stretching method of stretching the crystallizable resin film in the width direction simultaneously with stretching the crystallizable resin film in the lengthwise direction and a sequential biaxial stretching method of stretching the crystallizable resin film in one of the lengthwise and width directions, followed by stretching the crystallizable resin film in the other direction; and a method of stretching the crystallizable resin film in an oblique direction that is not parallel to or perpendicular to the width direction thereof (oblique stretching method) such as an oblique direction of exceeding 0° and less than 90° relative to the width direction.

Examples of the longitudinal uniaxial stretching may include a stretching method utilizing a difference in a peripheral speed between rolls.

Examples of the transversal uniaxial stretching method may include a stretching method using a tenter stretching machine.

Examples of the simultaneous biaxial stretching method described above may include a stretching method using a tenter stretching machine provided with a plurality of clips that are provided so as to be movable along a guide rail and capable of fixing the crystallizable resin film, wherein the crystallizable resin film is stretched in the lengthwise direction by increasing intervals between the clips, and simultaneously stretched in the width direction using a spreading angle of the guide rail.

Examples of the sequential biaxial stretching method may include a stretching method in which the crystallizable resin film is stretched in the lengthwise direction using a difference in a peripheral speed between rolls, both ends of the crystallizable resin film are then gripped by clips, and the crystallizable resin film is stretched in the width direction by the tenter stretching machine.

Examples of the oblique stretching method may include a stretching method in which the crystallizable resin film is continuously stretched in the oblique direction using a tenter stretching machine that is capable of applying a feeding force, a pulling force, or a drawing force to the crystallizable resin film at different speeds on left and right sides in the lengthwise or width direction.

The stretching temperature when the crystallizable resin film is stretched is preferably Tg−30° C. or higher, and more preferably Tg−10° C. or higher, and is preferably Tg+60° C. or lower, and more preferably Tg+50° C. or lower, relative to the glass transition temperature Tg of the alicyclic structure-containing polymer. By performing stretching in such a temperature range, it is possible to properly give orientation to the polymer molecules contained in the crystallizable resin film.

The stretching ratio for stretching the crystallizable resin film may be appropriately selected depending on the desired optical properties, thickness, strength, and the like, and is usually more than 1 time, and preferably 1.01 times or more, and is preferably 10 times or less, and more preferably 5 times or less. Herein, when the stretching is performed in a plurality of different directions such as a case of the biaxial stretching method, the stretching ratio means a total stretching ratio that is represented by product of stretching ratios in the respective stretching directions. When the stretching ratio is equal to or less than the upper limit value of the aforementioned range, a possibility of breakage of the film can be reduced. Therefore, the optical film can be easily produced.

When the crystallizable resin film is subjected to the stretching treatment as described above, an optical film having desired properties can be obtained. Further, by performing the stretching treatment, haze of the optical film can be reduced. Without being bound by a particular theory, it is considered that orientation of the molecules of the crystallizable polymer accelerates the speed of crystallization in the crystallization step and thereby causes generation of the crystallized resin with smaller crystal nuclei, which results in such reduction in haze.

[5.4. Step (4)]

In the step (4), the crystallizable resin film in the multilayer product is crystallized. Crystallization may be performed by keeping the temperature to a specific temperature range while at least two edges of the multilayer product including the crystallizable resin film are held and thereby the multilayer product is in a state of being under tension.

The state in which the multilayer product is under tension is a state in which a tensile force is applied to the multilayer product. However, the state in which the multilayer product is under tension does not include a state in which the multilayer product is substantially stretched. The phrase “substantially stretched” means that the stretching ratio of the multilayer product in any direction is usually 1.1 times or more.

When the multilayer product is held, an appropriate holding tool is used to hold the multilayer product. The holding tool may be one that can continuously hold the edges of the multilayer product over the entire length thereof or one that can intermittently hold the edges of the multilayer product at intervals. For example, the edges of the multilayer product may be intermittently held by holding tools disposed with predetermined intervals.

In the crystallization step, the multilayer product is held by holding at least two edges of the multilayer product to be in a state of being under tension. This prevents deformation due to heat shrinkage of the multilayer product in the region between the held edges. In order to prevent deformation in a large area of the multilayer product, it is preferable to hold the edges including two opposite edges and to keep the region between the held edges in a state of being under tension. For example, as to a multilayer product in a rectangular sheet piece shape, two opposing edges (for example, the edges on the long side or the edges on the short side) to hold a region between the two edges to keep the region in a state of being under tension, so that deformation can be prevented over the entire surface of the multilayer product in a sheet piece shape. In the case of the long-length multilayer product, the two edges at the end in the width direction (i.e., the edges on the long side) are held to keep the region between the two edges in a state of being under tension, so that deformation can be prevented over the entire surface of the long-length multilayer product. In the multilayer product that is prevented from being deformed in this manner, even when stress is generated in the film by heat shrinkage, occurrence of deformation such as wrinkling is prevented. When the stretched film having been subjected to the stretching treatment is used as the multilayer product, deformation can be prevented more reliably by holding at least two edges orthogonal to the stretching direction (in the case of biaxial stretching, the direction in which the stretching ratio is larger).

In order to more reliably prevent the deformation in the crystallization step, it is preferable to hold a larger number of edges. Therefore, for example, in the case of a multilayer product in a sheet piece shape, it is preferable to hold all of the edges thereof. As a specific example, in the case of a multilayer product in a rectangular sheet piece shape, it is preferable to hold four edges thereof.

As a holding tool capable of holding the edge of the multilayer product, a tool that does not come in contact with the multilayer product in a portion other than the edges of the multilayer product is preferable. By using such a holding tool, an optical film having better smoothness can be obtained.

The holding tools are preferably capable of fixing the relative positions between the holding tools in the crystallization step. Since the relative positions between such holding tools do not change in the crystallization step, substantial stretching of the multilayer product in the crystallization step can be easily suppressed.

In the case of holding tools for holding a rectangular multilayer product, examples of preferable holding tools may include grippers, such as clips, that are provided on a frame at specific intervals so as to be able to grip the edges of the multilayer product. In the case of holding tools for holding the two edges of a long-length multilayer product at the width-direction ends of the film, examples thereof may include grippers that are provided in a tenter stretching machine so as to be able to grip the edges of the multilayer product.

When a long-length multilayer product is used, edges at the lengthwise-direction ends (i.e., edges on the short side) of the multilayer product may be held. However, as an alternative to such holding of the edges, the both sides of a region subjected to a crystallization treatment in the lengthwise direction of the multilayer product may be held. For example, holding devices that can hold the multilayer product in a state of being under tension so as to prevent occurrence of heat shrinkage may be provided on both sides of a region subjected to a crystallization treatment in the lengthwise direction of the multilayer product. Examples of such holding devices may include a combination of two rolls and a combination of an extruder and a take-up roll. By applying a tensile force, such as feeding tension, to the multilayer product with the use of such a combination of holding devices, it is possible to prevent thermal shrinkage of the multilayer product in a region subjected to a crystallization treatment. Therefore, by using such a combination as the holding devices, the multilayer product can be held while being fed in the lengthwise direction, which makes it possible to efficiently produce an optical film.

In the crystallization step, the multilayer product is brought to a temperature higher than or equal to the glass transition temperature Tg of the alicyclic structure-containing polymer and lower than or equal to the melting point Tm of the alicyclic structure-containing polymer while at least two edges of the multilayer product are held and thereby the multilayer product is in a state of being under tension as described above. In the multilayer product brought to the above-mentioned temperature, crystallization of the alicyclic structure-containing polymer proceeds. Thus, a crystallized film containing a crystallized alicyclic structure-containing polymer is obtained by this crystallization step. At this time, since the crystallized film is kept in a tensioned state while preventing deformation of the crystallized film, crystallization can be promoted without impairing the smoothness of the crystallized film.

As described above, the temperature range in the crystallization step may be optionally set within a temperature range of the glass transition temperature Tg of the alicyclic structure-containing polymer or higher and the melting point Tm of the alicyclic structure-containing polymer or lower. Among these, it is preferable to set the temperature so as to increase the speed of crystallization. The temperature of the multilayer product in the crystallization step is preferably Tg+20° C. or higher, and more preferably Tg+30° C. or higher, and is preferably Tm−20° C. or lower, and more preferably Tm−40° C. or lower. Since the clouding of the first layer can be prevented by setting the temperature in the crystallization step to the upper limit of the above-mentioned range or lower, an optical film suitable for the case where an optically transparent film is required can be obtained.

When the multilayer product is brought to the above-mentioned temperature, heating of the multilayer product is usually performed. As the heating device used at this time, since contact between the heating device and the multilayer product is unnecessary, a heating device capable of raising the atmosphere temperature of the multilayer product is preferable. Specific examples of suitable heating devices may include an oven and a heating furnace.

In the crystallization step, the treatment time for maintaining the multilayer product in the above-mentioned temperature range is preferably 1 second or more, and more preferably 5 seconds or more, and is preferably 30 minutes or less, and more preferably 10 minutes or less. By sufficiently promoting the crystallization of the alicyclic structure-containing polymer in the crystallization step, flexibility of the optical film can be enhanced. By setting the treatment time to the upper limit or lower of the above-mentioned range, clouding of the first layer can be prevented, and thereby an optical film suitable for a case where an optically transparent film is required can be obtained.

By subjecting the multilayer product to the crystallization step by heat treatment, the easy-adhesion layer is also subjected to heat treatment together with the crystallizable resin film. However, in the method for producing the optical film of the present invention, by employing a layer of a urethane resin as the easy-adhesion layer, the function of the easy-adhesion layer can still be maintained even after such a heat treatment.

Further, according to the findings of the present inventor, the function of the easy-adhesion layer can be favorably exhibited better when the easy-adhesion layer is formed and then the crystallization treatment is performed than when the easy-adhesion layer is formed on the film having been subjected to the crystallization treatment. Therefore, the method for producing an optical film of the present invention is particularly advantageous in obtaining an optical film having high adhesiveness.

[5.5. Other Steps]

In the production method of the present invention, optional steps may be performed in addition to the above-described steps.

Examples of the optional steps may include a step of subjecting the surface of the crystallizable resin film to a modification treatment prior to the step (2). By performing such a treatment, the adhesion between the first layer and the easy-adhesion layer can be improved.

Examples of the optional steps may further include a step of subjecting the surface of the easy-adhesion layer to a modification treatment after the step (2). By performing such a treatment, the adhesion between the easy-adhesion layer and other members can be improved. Since the surface of the easy-adhesion layer usually acts as a bonding surface when the optical film of the present invention is bonded to another member, further improvement in hydrophilicity of this surface results in remarkable improvement in the adhesion between the optical film of the present invention and another member.

Examples of the modification treatment on the surface of the crystallizable resin film and the modification treatment on the surface of the easy-adhesion layer may include a corona discharge treatment, a plasma treatment, a saponification treatment, and an ultraviolet irradiation treatment. Among these, the corona discharge treatment and the plasma treatment are preferable from the viewpoint of the treatment efficiency and the like, and the corona discharge treatment is more preferable.

Examples of the optional steps may further include a relaxation step in which the layer of the crystallized resin is heat shrunk to remove residual stresses after the step (4).

[6. Optional Layer]

The optical film of the present invention may include an optional layer in addition to the first layer and the easy-adhesion layer. For example, in addition to one layer of the first layer and one layer of the easy-adhesion layer, an optional layer may be provided on the opposite side of the first layer to the easy-adhesion layer. Examples of the optional layers may include an electroconductive layer, an anti-reflective layer, a hard coat layer, an antistatic layer, an anti-glare layer, an anti-fouling layer, and a separator film.

[7. Multilayer Film]

The multilayer film of the present invention includes the optical film of the present invention, an adhesive layer disposed on the surface of the optical film on the easy-adhesion layer side, and a second layer disposed on the adhesive layer.

As the adhesive constituting the adhesive layer, various adhesives capable of achieving satisfactory adhesion with the layer of a urethane resin may be used. Specific examples thereof may include an ultraviolet curable acrylic composition, an ultraviolet curable epoxy composition, and an ultraviolet curable polymer composition in which an acrylic monomer and an epoxy monomer are mixed.

The second layer may be any member that can be used as a component of a display device and that can readily achieve adhesion by the adhesive layer. Specifically, a layer of an inorganic material such as a glass plate or a metal plate, and a layer of a resin may be used. Examples of the materials constituting the resin layer may include an amorphous alicyclic structure-containing polymer resin, a resin containing a polyvinyl alcohol as a main component constituting a polarizer of a polarizing plate, a cellulose-based resin constituting a polarizing plate protective film, a crystallizable alicyclic structure-containing polymer resin, and a crystallizable polyester-based resin.

The multilayer film of the present invention may be produced by bonding the surface of the optical film of the present invention on the easy-adhesion layer side and the second layer via an adhesive. Specifically, the multilayer film can be produced by applying an adhesive onto either or both of the surface of the optical film of the present invention on the easy-adhesion layer side and one surface of the second layer, stacking these on each other, and further curing the adhesive if necessary.

The multilayer film of the present invention can be a multilayer film having properties such as high heat resistance and flexibility based on the first layer formed of the crystallized resin, high adhesiveness between the first layer and the second layer via the easy-adhesion layer and the adhesive layer, and as a result, high peel strength, little tendency for peeling between layers to occur, and high durability.

[8. Use Application]

The optical film and the multilayer film of the present invention may be used in any use application. In particular, by taking advantage of high flexibility, the optical film may be used particularly usefully as a touch sensor which is a component of a touch panel.

### EXAMPLES

Hereinafter, the present invention will be specifically described by illustrating Examples. However, the present invention is not limited to the Examples described below. The present invention may be optionally modified for implementation without departing from the scope of claims of the present invention and its equivalents.

In the following description, “%” and “part” representing quantity are on the basis of weight, unless otherwise specified. The operations described below were performed under the conditions of normal temperature and normal pressure, unless otherwise specified.

<Evaluation Methods>

### (Method for Measuring Thickness)

The thickness of each layer constituting the optical film and the multilayer film was measured as follows. The refractive index of each layer of the film as a sample was measured using an ellipsometer (“M-2000” manufactured by J. A. Woollam Co., Inc.). Then, the film thickness was measured with an optical interference film thickness meter (“MCPD-9800” manufactured by Otsuka Electronics Co., Ltd.) using the refractive index thus measured.

(Weight-Average Molecular Weight and Number-Average Molecular Weight)

The weight-average molecular weight and the number-average molecular weight of the polymer were measured as polystyrene-equivalent values using a gel permeation chromatography (GPC) system (“HLC-8320” manufactured by Tosoh Corp.). In the measurement, the H-type column (manufactured by Tosoh Corp.) was used as the column and tetrahydrofuran was used as the solvent. Further, the temperature during the measurement was 40° C.

(Glass Transition Temperature Tg, Melting Point Tm, and Crystallization Temperature Tpc of Crystallizable Resin)

A sample heated to 300° C. in a nitrogen atmosphere was rapidly cooled by liquid nitrogen, and then the temperature was elevated at a rate of 10° C./min using a differential scanning calorimeter (DSC) to determine the glass transition temperature Tg, the melting point Tm, and the crystallization temperature Tpc of the sample.

(Glass Transition Temperature of Urethane Resin)

The material Y including the urethane resin used in Example was poured into a Teflon (registered trademark)—coated container and dried for 24 hours at normal temperature. Subsequently, the material Y was further dried in an oven at 120° C. for 1 hour to prepare a sheet-shaped product of the urethane resin having a thickness of 150 μm. The glass transition temperature of the sheet-shaped product was measured from a peak of tan δ using a dynamic viscoelasticity measuring device (“Rheogel-E4000” manufactured by UBM). If two peaks were observed in this measurement, a peak appearing at a lower temperature was adopted as the glass transition temperature.

(Method for Measuring Hydrogenation Rate of Polymer)

The hydrogenation rate of the polymer was measured by ¹H-NMR measurement at 145° C. using orthodichlorobenzene-d⁴ as a solvent.

(Racemo Diad Ratio in Polymer)

¹³C-NMR measurement of the polymer was performed by applying the inverse-gated decoupling method at 200° C. using orthodichlorobenzene-d⁴ as a solvent. From the result of the ¹³C-NMR measurement, a signal attributable to the meso diad at 43.35 ppm and a signal attributable to the racemo diad at 43.43 ppm were identified with a peak of orthodichlorobenzene-d⁴ at 127.5 ppm as a reference shift, and the racemo diad ratio in the polymer was determined on the basis of the intensity ratio therebetween.

(Crystallization Degree)

The crystallization degree was confirmed by the X-ray diffraction in accordance with JIS K 0131. Specifically, the X-ray diffraction intensity from the crystallized area was obtained using a wide-angle X-ray diffractometer (RINT 2000 manufactured by Rigaku Corp.), and the crystallization degree was obtained from a ratio of the X-ray diffraction intensity from the crystallized part with respect to the overall X-ray diffraction intensity by the following formula (I).

Xc=K·Ic/It (I)

In the above formula (I), Xc represents the crystallization degree of the tested sample, Ic represents the X-ray diffraction intensity from the crystallized area, It represents the overall X-ray diffraction intensity, and K represents a correction factor.

(Measurement of Peel Strength)

The multilayer films obtained in Example and Comparative Example were each cut into a 25 mm width and its surface on the first layer side was bonded to a slide glass surface with a tackiness agent to obtain a bonded product. For bonding, a double-sided tackiness agent tape (a product number “CS9621” manufactured by Nitto Denko Corp.) was used as the tackiness agent. After bonding, the bonded product was left stand still for 12 hours.

Subsequently, an end portion of the second layer was held by a gripper attached to the tip of the force gauge and pulled up in a normal direction of the slide glass surface, to thereby perform a 90 degree peel test. A peeling speed in this pulling was 20 ram/min. Since the force measured during peeling of the second layer was a force required for peeling of the second layer from the optical film, the magnitude of this force was measured as the peel strength.

(Method for Measuring Haze of Optical Film)

The crystallized resin layer of the optical film was cut with the central portion of the optical film being the center of a 50 mm×50 mm square shape, to thereby obtain a sample. The haze of this sample was measured using a haze meter (“Turbid meter NDH-300A” manufactured by Nippon Denshoku Industries, Co., Ltd.).

(Method for Measuring in-Plane Retardation Re and Thickness Direction Retardation Rth of Optical Film)

The in-plane retardation Re and the thickness direction retardation Rth of the optical film were measured with a measurement wavelength of 590 nm using a birefringence measurement instrument “AxoScan” (manufactured by Axometrics, Inc.).

### Production Example 1. Production of Hydrogenated Product of Ring-Opening Polymer of Dicyclopentadiene

A pressure-resistant metal reaction vessel was sufficiently dried and then the atmosphere in the vessel was substituted with nitrogen. Into this pressure-resistant metal reaction vessel, 154.5 parts of cyclohexane, 42.8 parts (30 parts as the amount of dicyclopentadiene) of a 70%-concentration cyclohexane solution of dicyclopentadiene (an endo-isomer content of 99% or more), and 1.9 parts of 1-hexene were added, and the resulting mixture was heated to 53° C.

0.061 part of a 19%-concentration diethylaluminum ethoxide/n-hexane solution was added into a solution that was obtained by dissolving 0.014 part of a tetrachlorotungsten phenylimide (tetrahydrofuran) complex into 0.70 part of toluene, and the resulting mixture was stirred for 10 minutes to prepare a catalyst solution.

This catalyst solution was added in the pressure-resistant reaction vessel to initiate a ring-opening polymerization reaction. Subsequently, the reaction was performed for 4 hours while being kept at 53° C. to obtain a solution of a ring-opening polymer of dicyclopentadiene.

The number-average molecular weight (Mn) and the weight-average molecular weight (Mw) of the ring-opening polymer of dicyclopentadiene thus obtained were 8,750 and 28,100, respectively, and the molecular weight distribution (Mw/Mn) determined from these results was 3.21.

To 200 parts of the solution of the ring-opening polymer of dicyclopentadiene thus obtained, 0.037 part of 1,2-ehanediol as a terminator was added, and the resulting mixture was heated to 60° C. and stirred for 1 hour to terminate the polymerization reaction. 1 part of a hydrotalcite-like compound (“Kyoward (registered trademark) 2000” manufactured by Kyowa Chemical Industry Co., Ltd.) was added to this mixture, and the resulting mixture was heated to 60° C. and stirred for 1 hour. Subsequently, 0.4 part of a filter aid (“Radiolite (registered trademark) #1500” manufactured by Showa Chemical Industry Co., Ltd.) was added to the mixture, and the resulting mixture was filtered using a PP pleated cartridge filter (“TCP-HX” manufactured by Advantec Toyo Kaisha, Ltd.) to separate the adsorbent from the solution.

To 200 parts (the polymer amount of 30 parts) of the filtered solution of the ring-opening polymer of dicyclopentadiene, 100 parts of cyclohexane were added. To this mixture, 0.0043 part of chlorohydridocarbonyltris(triphenylphosphine)ruthenium was added, to thereby perform the hydrogenation reaction at a hydrogen pressure of 6 MPa and 180° C. for 4 hours. In this manner, a reaction liquid including the hydrogenated product of the ring-opening polymer of dicyclopentadiene was obtained. This reaction liquid was obtained as a slurry solution in which the hydrogenated product was deposited.

The hydrogenated product contained in the aforementioned reaction liquid was separated from the solution using a centrifuge, and the separated hydrogenated product was dried under reduced pressure at 60° C. for 24 hours to obtain 28.5 parts of the hydrogenated product of the ring-opening polymer of dicyclopentadiene having crystallizability. This hydrogenated product had the hydrogenation rate of 99% or more, the glass transition temperature Tg of 94° C., the melting point (Tm) of 262° C., the crystallization temperature Tpc of 170° C., and the racemo diad ratio of 89%.

### Example 1

(1-1. Production of Crystallizable Resin Film Having Crystallization Degree of Less than 3%)

0.5 part of an antioxidant (tetrakis[methylene-3-(3′,5′-di-t-butyl-4′-hydroxyphenyl)propionate]methane; “Irganox (registered trademark) 1010” manufactured by BASF SE) was mixed to 100 parts of the hydrogenated product of the ring-opening polymer of dicyclopentadiene obtained in Production Example 1, to thereby obtain a crystallizable resin serving as a material of the first layer. This crystallizable resin is hereinafter referred to as a “resin A”.

The resin A was charged into a biaxial extruder (“TEM-37B” manufactured by Toshiba Machine Co. Ltd.) having four die holes each having an inner diameter of 3 mmϕ. With the biaxial extruder described above, the resin was molded into a strand-like molded product by hot melt extrusion molding. This molded product was finely cut with a strand cutter to obtain pellets of the resin A.

Subsequently, the obtained pellets were supplied to a hot-melt extrusion film-molding machine equipped with a T die. A long-length film (having a width of 120 mm) formed of the aforementioned resin A was produced by using this film molding machine with a method of winding up the film into a roll at a speed of 27 m/min. The operation conditions of the aforementioned film molding machine are as follows.
Barrel set temperature: 280° C. to 290° C.
Die temperature: 270° C.
Screw rotation speed: 30 rpm
Casting roll temperature: 70° C.

In this manner, a long-length resin A film was obtained. The thickness of the film thus obtained was 20 μm. The crystallization degree of the resin A in this film was 0.7%.

(1-2. Preparation of Material Y)

100 parts in terms of the polyurethane amount of an aqueous dispersion of a carbonate-based polyurethane (product name “ADEKA BONTIGHTER SPX0672” manufactured by Adeka Corp, glass transition temperature of −16° C.) as a main component, 2.7 parts of a polyfunctional epoxy compound (product name “Denacol EX-521” manufactured by Nagase ChemteX Corp.) as a crosslinking agent, 0.18 part with respect to the total water content of acetylenic glycol (product name “SURFYNOL 440” manufactured by Nissin Chemical Co., Ltd.) as a surfactant, and ion exchange water as a solvent were mixed to obtain a material Y including the urethane resin with a solid content concentration of 30%. In this operation, the term “total water content” refers to the total amount of water included in the aqueous dispersion of the polyurethane and added water.

(1-3. Production of Multilayer Product Including Crystallizable Resin Film and Easy-Adhesion Layer)

The surface of the film obtained in (1-1) was subjected to a discharge treatment using a corona treatment device (manufactured by Kasuga Denki Inc.) under conditions of an output power of 500 W, an electrode length of 1.35 m, and a conveyance speed of 15 m/min. The material Y obtained in (1-2) was applied onto the discharge-treated surface of the film obtained in (1-1) using a roll coater. The coating thickness was adjusted such that the thickness after drying became a desired value. Subsequently, the material Y was dried under drying conditions of a drying temperature of 90° C. and a drying time of 120 seconds to form a layer of the urethane resin as the easy-adhesion layer on the surface of the crystallizable resin film. In this manner, a long-length multilayer product including the crystallizable resin film and the easy-adhesion layer. The thickness of the easy-adhesion layer in the multilayer product thus obtained was 500 nm.

(1-4. Setting to Compact Stretching Machine)

The long-length multilayer product obtained in (1-3) was cut into a 350 mm×350 mm square. The cutting was performed such that each edge of the square cut out from the multilayer product was parallel to the lengthwise direction or the width direction of the long-length multilayer product. Then, the multilayer product thus cut out was set to a compact stretching machine (“EX10-B” manufactured by Toyo Seiki Seisaku-sho, Ltd.). This compact stretching machine is equipped with a plurality of clips that can hold four edges of the film and thus has a structure capable of stretching the film by moving these clips.

(1-5. Optical Film)

The multilayer product set to the compact stretching machine in (1-4) was subjected to a heating treatment. The heating treatment was performed such that secondary heating plates that were the equipment of the compact stretching machine were brought in a proximity of the upper and lower surfaces of the multilayer product and kept this state for 30 seconds while the four edges of the multilayer product were being held. In this treatment, the temperature of the secondary heating plates was set to 170° C. and the upper and lower distances between the secondary heating plates and the film were each set to 8 mm. Under such conditions, crystallization of the crystallizable resin film in the multilayer product proceeded to yield a layer of the crystallized resin. In this manner, an optical film including the crystallized resin layer as the first layer and the easy-adhesion layer was obtained.

The crystallization degree of the crystallized resin in the optical film thus obtained was 71%. Further, the haze, the in-plane retardation Re, and the thickness direction retardation Rth of the optical film thus obtained were measured.

(1-6. Multilayer Film)

A film made of a resin including a norbornene-based polymer (product name “ZEONOR Film ZF16-100”, glass transition temperature of 160° C., thickness of 100 μm, not being subjected to stretching treatment, manufactured by ZEON Corporation) was prepared.

One surface of the resin film described above and the surface of the optical film obtained in (1-4) on the easy-adhesion layer side were subjected to a corona treatment. The corona treatment was performed using the corona treatment device manufactured by Kasuga Denki Inc. under treatment conditions of a discharge amount of 150 W/m²/min in the atmospheric air.

A UV ray-curable adhesive (CRB1352 manufactured by Toyo Ink Co., Ltd.) was applied onto the corona-treated surface of the resin film and this surface was bonded to the corona-treated surface of the optical film by using a laminator.

The bonded product was irradiated with UV rays using a high pressure mercury lamp under conditions of an illuminance of 350 mW/cm² and an integrated light quantity of 1,000 mJ/cm². In this manner, the adhesive was crosslinked to form an adhesive layer.

In a manner described above, the multilayer film including the crystallized resin layer as the first layer, the easy-adhesion layer, the adhesive layer, and the resin film layer as the second layer in this order was obtained.

The peel strength of the multilayer film thus obtained was measured.

### Example 2

(2-1. Stretching Step)

A long-length multilayer product was prepared by the same manner as that of (1-1) to (1-3) of Example 1. The long-length multilayer product obtained in (1-3) was set to the compact stretching machine by the same manner as that of (1-4) in Example 1.

The oven temperature of the compact stretching machine was set at 130° C., and the multilayer product was stretched using this machine at a stretching temperature of 130° C. and a stretching speed of 4.0 mm/min in a direction corresponding to the lengthwise direction of the long-length multilayer product at a stretching ratio of 1.2 times, to thereby obtain a stretched multilayer product.

(2-2. Crystallization step)

In (1-5) of Example 1, a stretched multilayer product which was in a state of being set to the compact stretching machine at the time when the process of (2-1) had been completed was used instead of the multilayer product being set to the compact stretching machine in (1-4). Except for this change, an optical film and a multilayer film were obtained and evaluated by the same manner as that of (1-5) to (1-6) of Example 1. The crystallization degree of the crystallized resin in the optical film thus obtained was 73%. The thickness of the easy-adhesion layer of the optical film was 417 nm.

### Example 3

In (2-1) of Example 2, the stretching ratio was changed from 1.2 times to 2.0 times. Except for this change, an optical film and a multilayer film were obtained and evaluated by the same manner as that of Example 2. The crystallization degree of the crystallized resin in the obtained optical film was 75%. The thickness of the easy-adhesion layer of the optical film was 250 nm.

### Comparative Example 1

Except for the following changes, an optical film formed of only a crystallized resin layer and a multilayer film including the optical film were obtained and evaluated by the same manner as that of (1-1) and (1-4) to (1-6) of Example 1.
In (1-4), the long-length film obtained in (1-1) as it was set to the compact stretching machine instead of the long-length multilayer product obtained in (1-3).
In the formation of the multilayer film in (1-6), corona treatment and bonding of the optical film were performed on one side of the crystallized resin layer. Therefore, the multilayer film had the crystallized resin layer as the first layer, the adhesive layer, and the resin film layer as the second layer in this order.

The crystallization degree of the crystallized resin in the optical film thus obtained was 71%.

### Comparative Example 2

(C2-1. Stretching Step)

In (1-4) of Example 1, the long-length film obtained in (1-1) as it was set to the compact stretching machine instead of the long-length multilayer product obtained in (1-3) of Example 1.

The oven temperature of the compact stretching machine was set at 130° C., and the multilayer product was stretched using this machine at a stretching temperature of 130° C. and a stretching speed of 4.0 mm/min in a direction corresponding to the lengthwise direction of the long-length multilayer product at a stretching ratio of 1.2 times, to thereby obtain a stretched multilayer product.

(C2-2. Crystallization Step)

Except for the following changes, an optical film formed of only a crystallized resin layer and a multilayer film including the optical film were obtained and evaluated by the same manner as that of (1-5) to (1-6) of Example 1.
In the formation of the optical film in (1-5), a stretched film which was in a state of being set to the compact stretching machine at the time when the process of (C2-1) had been completed was used instead of the multilayer product being set to the compact stretching machine in (1-4).
In the formation of the multilayer film in (1-6), corona treatment and bonding of the optical film were performed on one side of the crystallized resin layer. Therefore, the multilayer film had the crystallized resin layer as the first layer, the adhesive layer, and the resin film layer as the second layer in this order.

The crystallization degree of the crystallized resin in the optical film thus obtained was 73%.

### Comparative Example 3

In (C2-1) of Comparative Example 2, the stretching ratio was changed from 1.2 times to 2.0 times. Except for this change, an optical film formed of only the crystallized resin layer and a multilayer film including the optical film were obtained and evaluated by the same manner as that of Comparative Example 2.

The crystallization degree of the crystallized resin in the optical film thus obtained was 75%.

<Results>

The results of Examples and Comparative Examples are shown in Table 1.

TABLE 1
[Results of Examples 1-3 and Comparative Examples 1-3]

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| Thickness of easy- | 500 | 417 | 250 | — | — | — |
| adhesion layer | | | | | | |
| (nm) | | | | | | |
| Stretching temperature | — | 130 | 130 | — | 130 | 130 |
| (° C.) | | | | | | |
| Stretching ratio | — | 1.2 | 2.0 | — | 2.0 | 1.2 |
| (times) | | | | | | |
| Stretching speed | — | 4.0 | 4.0 | — | 4.0 | 4.0 |
| (mm/min) | | | | | | |
| Crystallization | 170 | 170 | 170 | 170 | 170 | 170 |
| step temperature | | | | | | |
| (° C.) | | | | | | |
| Treatment time | 30 | 30 | 30 | 30 | 30 | 30 |
| in crystallization | | | | | | |
| step | | | | | | |
| (sec) | | | | | | |
| Peel strength | 2.2 | 2.0 | 1.0 | Less | Less | Less |
| (N/25 mm) | | | | than | than | than |
| | | | | 0.1 | 0.1 | 0.1 |
| Haze (%) | 2.5 | 0.1 | 0.08 | 2.5 | 0.1 | 0.08 |
| Re (nm) | 0.2 | 1.5 | 120 | 0.2 | 1.5 | 120 |
| Rth (nm) | 5 | 10 | 80 | 5 | 10 | 80 |

### DISCUSSION

As can be seen from the results in Table 1, optical films having high peeling strength were obtained in Examples compared to Comparative Examples. Furthermore, the optical films produced by the production method including the stretching step had particularly low haze.

1. An optical film comprising a first layer, and an easy-adhesion layer disposed on at least one surface of the first layer, wherein
the first layer is a layer of a crystallized resin including an alicyclic structure-containing polymer, and
the easy-adhesion layer is a layer of a urethane resin.

2. The optical film according to claim 1, wherein a haze of the first layer is 3.0% or less.

3. The optical film according to claim 1, wherein the urethane resin contains a polycarbonate-based polyurethane containing a carbonate structure in a skeleton thereof.

4. A method for producing the optical film according to claim 1, comprising:
a step (1) of molding a crystallizable resin including an alicyclic structure-containing polymer to obtain a crystallizable resin film having a crystallization degree of less than 3%;
a step (2) of forming an easy-adhesion layer on the surface of the crystallizable resin film to obtain a multilayer product including the crystallizable resin film and the easy-adhesion layer; and
a step (4) of crystallizing the crystallizable resin film in the multilayer product.

5. The method for producing the optical film according to claim 4, further comprising a step (3) of stretching the crystallizable resin film prior to the step (4).

6. A multilayer film comprising:
the optical film according to claim 1;
an adhesive layer disposed on a surface of the optical film on the easy-adhesion layer side; and
a second layer disposed on the adhesive layer.
